(19) United States
(12) Patent Application Publication
(10) Pub. No.: US 2011/0080376 A1
(43) Pub. Date: Apr. 7, 2011

(54) TOUCH DISPLAY PANEL AND DISPLAY APPARATUS

(75) Inventors: Jing-Tin Kuo, Taipei City (TW); Mei-Sheng Ma, Taipei City (TW); Kuo-Hsien Lee, Taipei City (TW)

(73) Assignee: Au Optronics Corporation, Hsinchu (TW)

(21) Appl. No.: 12/618,780

(22) Filed: Nov. 16, 2009

(30) Foreign Application Priority Data
Oct. 5, 2009 (TW) 98133689

(51) Int. Cl. G06F 3/043; G06F 3/041

(52) U.S. Cl. 345/177; 345/173; 345/60; 345/104

(57) ABSTRACT

A touch display panel including a first substrate, a touch sensing device, and a display medium layer is provided. The first substrate has a display area and a non-display area located outside the display area. The touch sensing device may be directly disposed on the first substrate and located within the non-display area, wherein the touch sensing device is consisted of two or more groups of receiving elements. The display medium layer is disposed in the display area.

### CROSS-REFERENCE TO RELATED APPLICATION

This application claims the priority benefit of Taiwan application serial no. 98133689, filed on Oct. 5, 2009. The entirety of the above-mentioned patent application is hereby incorporated by reference herein and made a part of specification.

### BACKGROUND OF THE DISCLOSURE

1. Technical Field

The disclosure is related to a touch display panel and a display apparatus, and particularly to a touch display panel and a display apparatus with at least the characteristics of high manufacturing precision, low transmitting line resistance, narrow non-display area, low electricity consumption, and capable of writing by conductive objects and insulating objects.

2. Description of Related Art

Recently, touch panels can be generally categorized into resistance touch panels, capacitance touch panels, optical touch panels, acoustic wave touch panels, electromagnetic touch panels, etc. Among the touch panels, the acoustic wave touch panels positions the position of the touch point by sensing the acoustic wave generating during a touch, and thus the touch performed by a naked finger, a pen, or a finger wearing a glove on the touch panel can be sensed. In addition, when the size of the panel is increased, the quantity of the sensing devices applied in the acoustic wave touch panel does not need to be increased. Therefore, the cost for manufacturing the panel is not increased.

FIG. 1 is a schematic top view of a conventional acoustic wave touch panel. Referring to FIG. 1, a touch panel 100 includes a protective sheet 101, piezoelectrical components 112, 114, 116, and 118, transmitting lines 122, and signal pads 130. The protective sheet 101 is, for example, a cover glass for protecting a display panel and has a display area A1 and a non-display area A2. The piezoelectrical components 112, 114, 116, and 118, the transmitting lines 122, and the signal pads 130 are disposed in the non-display area A2. The piezoelectrical components 112 and 114 connected to the signal pads 130 through one of the transmitting lines 122 are considered as one group, and the piezoelectrical components 116 and 118 connected to the signal pads 130 through another transmitting line 122 are considered as the other group. One of the two groups including the piezoelectrical components 116 and 118 is used to emit a signal, and the other group including the piezoelectrical components 112 and 114 is used to receive the signal. The conventional acoustic wave touch panel having the above design is called an active acoustic wave touch panel.

Generally, the protective sheet 101 is used to cover and protect the display panel, and no electronic devices (such as transistor, capacitor, gate electrode, or other suitable devices) or circuits (such as data line, gate line, scan line, common line, or other suitable devices) are disposed on the protective sheet 101. Nevertheless, when the protective sheet 101 is used as the supporting substrate of a touch panel such as the touch panel 100, at least the transmitting lines 122 are necessary to be disposed on the protective sheet 101. For the convenience of the manufacturing method, the transmitting lines 122 are made by a screen printing method. Therefore, the transmitting lines 122 have higher resistance. For example, if the transmitting lines 122 are silver lines made by the screen printing method, the resistance of the transmitting lines 122 is about 100Ω/□.

In addition, the precision of the screen printing method is not desirable, and thus the line width and the pitch of the transmitting lines 122 are difficultly reduced. In a real design, the pitch of two transmitting lines 122 is at least 0.1 mm. In other words, a width W of the non-display area A2 of the touch panel 100 is further increased such that the space utilization of the products applying the touch panel 100 is not satisfactory. Furthermore, the display apparatus using the touch panel 100 has to configure with the protective sheet 101. Accordingly, the design of the display apparatus is restricted. That is to say, it is not possible to accomplish the acoustic wave touch function of the display apparatus without disposing the protective sheet 101.

### SUMMARY OF THE DISCLOSURE

The disclosure is directed to a touch display panel having high manufacturing precision and low transmitting line resistance.

The disclosure is also directed to a display apparatus having the above touch panel so as to reduce the width of the non-display area and the manufacturing cost.

The disclosure provides a touch display panel including a first substrate, a touch sensing device, and a display medium layer. The first substrate has a display area and a non-display area located outside the display area. The touch sensing device is disposed on the first substrate and located within the non-display area, wherein the touch sensing device is consisted of two or more groups of receiving elements. The display medium layer is disposed in the display area.

In an embodiment of the disclosure, each group of the receiving elements is consisted of one or more piezoelectrical components and a transmitting line, and the transmitting line serially connects the one or more piezoelectrical components. A line straightly connecting any two piezoelectrical components does not pass through the center of the display area.

In an embodiment of the disclosure, the first substrate has an active device array driving the display medium layer, and the display medium layer and the touch sensing device are located at a same side of the first substrate.

In an embodiment of the disclosure, the touch display panel further includes at least one shielding line disposed between the active device array and the touch sensing device and located in the non-display area, and the shielding line is applied to a ground voltage or a common voltage.

In an embodiment of the disclosure, the first substrate further has a first pad portion and a second pad portion respectively located in the non-display area, the touch sensing device is connected to the first pad portion, and the active device array is connected to the second pad portion. The first pad portion and the second pad portion are respectively located at different sides of the display area.

In an embodiment of the disclosure, the touch display panel further includes a second substrate, and the display medium layer is disposed between the first substrate and the second substrate. The display medium layer is a plasma layer or a liquid crystal layer.

In an embodiment of the disclosure, the touch panel further includes a first polarizer and a second polarizer, and the first substrate and the second substrate are located between the first polarizer and the second polarizer.

In an embodiment of the disclosure, the second substrate has an active device array driving the display medium layer, and the touch sensing device is disposed at a side of the first substrate away from the display medium layer.

In an embodiment of the disclosure, the first substrate or the second substrate has a color filter layer. The display medium layer is an electro-phoretic display film or an organic light emitting layer. A width of the non-display area is 1 mm to 10 mm.

The disclosure also provides a display apparatus including a frame and the above-mentioned touch display panel. The touch display panel is located inside the frame.

In an embodiment of the disclosure, the display apparatus further includes a protective sheet disposed on the frame and covering the touch display panel.

In an embodiment of the disclosure, the display apparatus further includes a display light source disposed between the frame and the touch display panel.

In view of the above, the touch sensing device is disposed on the first substrate of the touch display panel of the disclosure, and the transmitting lines can be made by the photo-lithography process and the etching process of the method for manufacturing the display panel. Therefore, the touch display panel according to the disclosure has high manufacturing precision, low transmitting line resistance, and narrow transmitting line width. In addition, the display apparatus according to the disclosure has the above-mentioned touch display panel with narrow non-display area to be conducive to enlarge the display area of the products using the same.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic top view of a conventional acoustic wave touch panel.

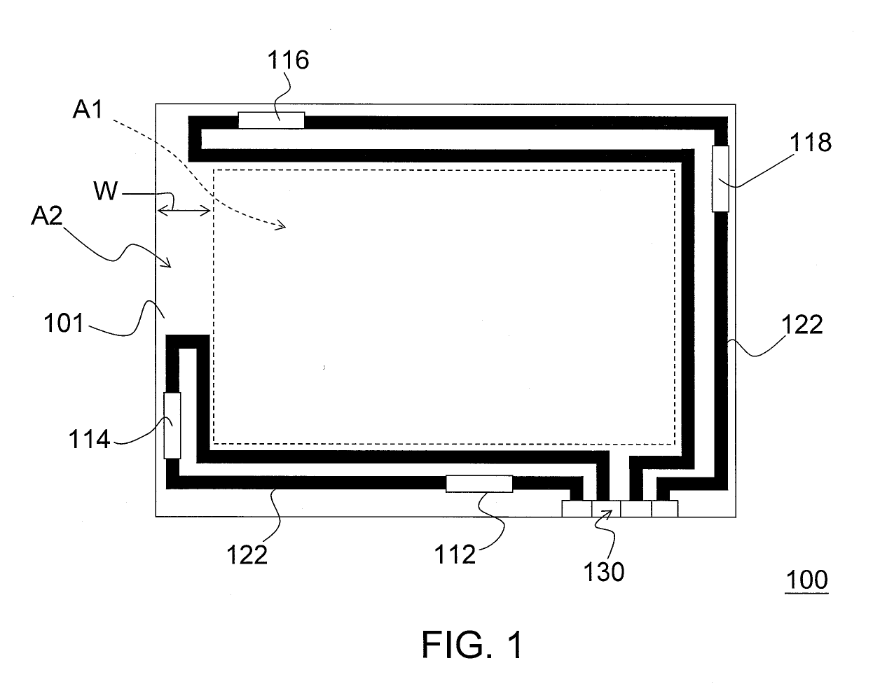

FIG. 2A is a schematic top view of a first substrate and the elements disposed thereon in a touch display panel according to an embodiment of the disclosure.

FIG. 2B is a schematic top view of a first substrate and the elements disposed thereon in a touch display panel according to another embodiment of the disclosure.

FIG. 3A is a schematic side view showing a touch display panel according to an embodiment of the disclosure.

FIG. 3B illustrates a touch panel of another embodiment of the disclosure.

FIG. 4 is a schematic top view of a first substrate and the elements disposed thereon in a touch display panel according to further another embodiment of the disclosure.

FIG. 5 is a schematic side view showing a touch display panel according to another embodiment of the disclosure.

FIG. 6A is a schematic view of a display apparatus according to an embodiment of the disclosure.

FIG. 6B is a schematic view of a touch display panel illustrated in FIG. 6A, wherein only a portion of the elements are shown.

FIG. 7A is a schematic view of a display apparatus according to another embodiment of the disclosure.

FIG. 7B is a schematic view of a touch display panel illustrated in FIG. 7A, wherein only a portion of the elements are shown.

### DESCRIPTION OF EMBODIMENTS

### Touch Display Panel

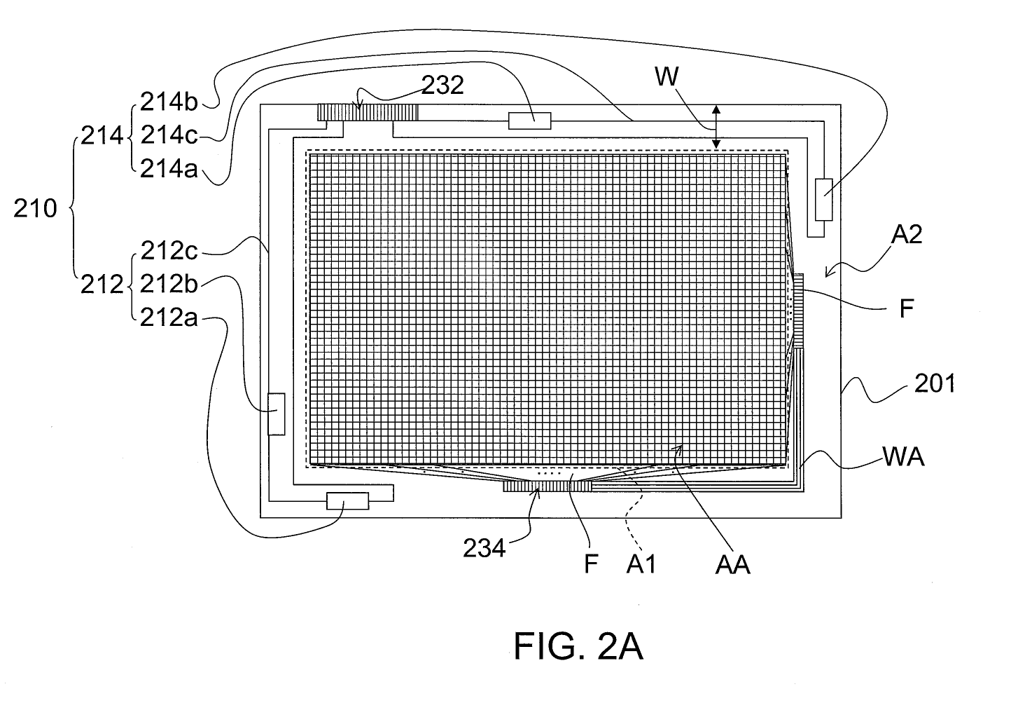

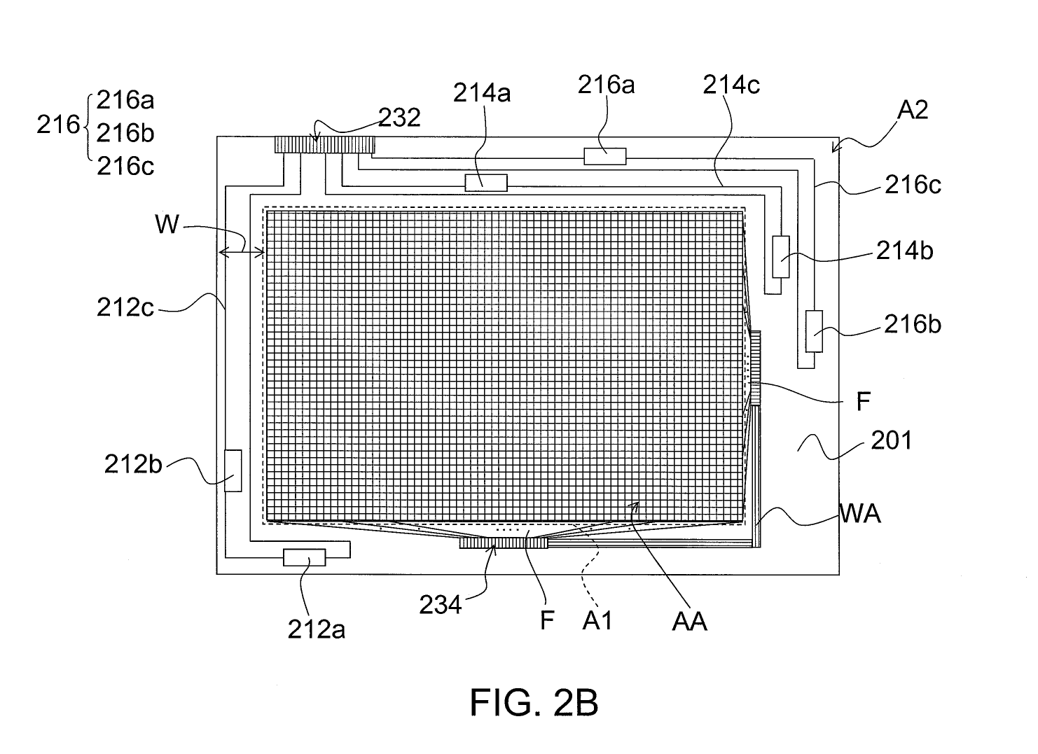

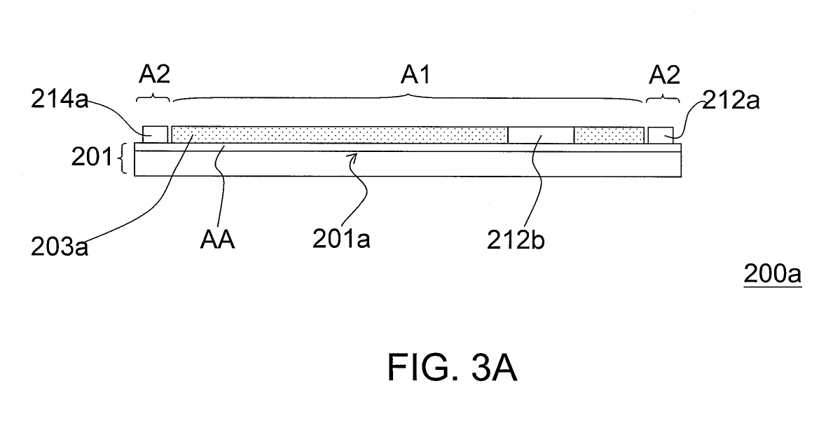

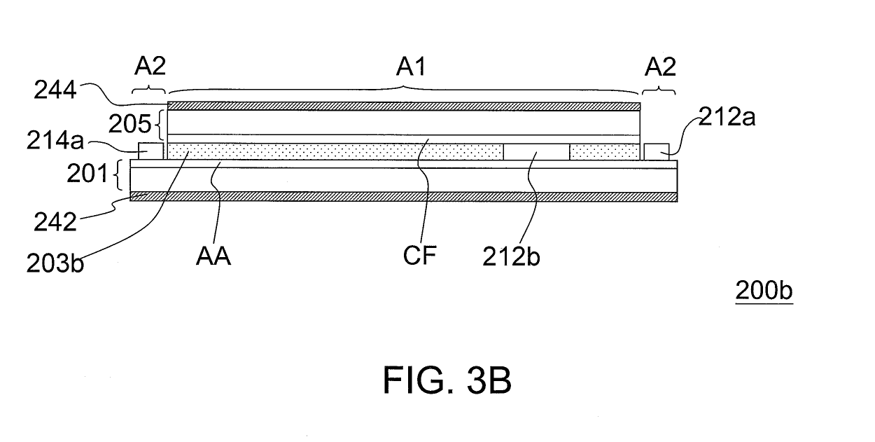

FIG. 2A is a schematic top view of a first substrate and the elements disposed thereon in a touch display panel according to an embodiment of the disclosure. FIG. 3A is a schematic side view showing a touch display panel according to an embodiment of the disclosure.

Referring to FIG. 2A, a touch sensing device 210 is disposed on a first substrate 201. The first substrate 201 has a display area A1 and a non-display area A2 located outside the display area A1. The touch sensing device 210 may be directly disposed on the first substrate 201, and located within the non-display area A2, wherein the touch sensing device 210 is consisted of two or more groups of receiving elements 212 and 214.

Specifically, the receiving elements 212 is consisted of the piezoelectrical component 212a, the piezoelectrical component 212b, and the transmitting line 212c, wherein the transmitting line 212c serially connects the two piezoelectrical components 212a and 212b. The receiving elements 214 is consisted of the piezoelectrical component 214a, the piezoelectrical component 214b, and the transmitting line 214c, wherein the transmitting line 214c serially connects the two piezoelectrical components 214a and 214b.

When the piezoelectrical components 212a, 212b, 214a, and 214b receive acoustic signals, the piezoelectrical components 212a, 212b, 214a, and 214b transform the acoustic signals into corresponding electrical signals. Therefore, if the touch panel 210 is touched, the touch position is positioned by analyzing the electrical signals generated by the piezoelectrical components 212a, 212b, 214a, and 214b. It is noted that the piezoelectrical components 212a, 212b, 214a, and 214b are all used for receiving signals, and thus the touch sensing device 210 is a passive acoustic touch sensing device. Accordingly, the touch sensing device 210 has simple structure and rapid response. In one embodiment, the working voltage of the piezoelectrical components 212a, 212b, 214a, and 214b is only about 1 mV to about 5 mV, for example. Therefore, the touch sensing device 210 has the characteristic of power consumption.

In addition, a line straightly connecting any two piezoelectrical components 212a, 212b, 214a, and 214b does not pass through the center of the display area A1. The positions of the piezoelectrical components 212a, 212b, 214a, and 214b are asymmetric so as to prevent from the mis-position caused by two different piezoelectrical components 212a, 212b, 214a, and 214b receiving the same acoustic signal. Herein, the asymmetric design means that the piezoelectrical components 212a, 212b, 214a, and 214b corresponding to the center of the form of the display area A1 are asymmetric. The receiving element 212 and the receiving element 214 respectively have two piezoelectrical components 212a and 212b and two piezoelectrical components 214a and 214b in the present embodiment. Nevertheless, the disclosure is not restricted herein, and the quantity and the position of the piezoelectrical components 212a, 212b, 214a, and 214b can be modified in other embodiments according to the requirement.

The first substrate 201 has an active device array AA in the present embodiment. The first substrate 201 further has a first pad portion 232 and a second pad portion 234 respectively located within the non-display area A2. The touch sensing device 210 is connected to the first pad portion 232, and the active device array AA is connected to the second pad portion 234. Specifically, the first pad portion 232 and the second pad portion 234 are respectively consisted of a plurality of pads (not marked). The first pad portion 232 and the second pad portion 234 are respectively located at different sides of the display area A1. In addition, the elements disposed in the display area A1 is electrically connected to the second pad portion 234 through the lines of fan-out area F and the wires on array WA. However, the disclosure is not limited thereto.

The first substrate 201 is an active device array substrate, so that the transmitting lines 212c and 214c can be formed by the photolithography process on the first substrate 201. Therefore, the method for manufacturing the transmitting lines 212c and 214c has higher precision. Compared with the conventional transmitting lines formed by the screen printing process, the transmitting line 212c and the transmitting line 214c are metal lines with higher density. Accordingly, the transmitting line 212c and the transmitting line 214c have lower resistance. In some embodiments, the resistances of the transmitting line 212c and the transmitting line 214c are about 0.1Ω/□ to about 2Ω/□. Therefore, the transmitting line 212c and the transmitting line 214c have desirable signal transmitting quality.

In particular, the line width of the transmitting line 212c and the transmitting line 214c can be effectively reduced by properly modulating the photolithography process and the metal deposition process. Therefore, the width W of the non-display area A2 can be significantly reduced. In some embodiments, the width W of the non-display area A2 is about 1 mm to about 10 mm.

FIG. 2B is a schematic top view of a first substrate and the elements disposed thereon in a touch display panel according to another embodiment of the disclosure. In FIG. 2A and FIG. 2B, identical elements are represented by the same reference numbers. Therefore, detailed descriptions thereof are not repeated hereinafter. It is noted that the touch sensing device 210 further has a third group of the receiving element 216 in the present embodiment illustrated in FIG. 2B. The third group of the receiving element 216 is consisted of the piezoelectrical component 216a, the piezoelectrical component 216b, and the transmitting line 216c, wherein the transmitting line 216c serially connects the two piezoelectrical components 216a and 216b. In FIG. 2B, some elements are overstated for clearly describing, therefore the width W of the non-display area A2 is smaller in a real circumstance.

As shown in FIG. 2B, the touch sensing device 210 has three groups of receiving elements 212, 214, and 216, so that the piezoelectrical components 212a, 212b, 214a, 214b, 216a, and 216b respectively generate corresponding electrical signals when the first substrate 201 is touched. Accordingly, the touch position of the first substrate 201 can be positioned according to the electrical signals generated by a plurality of groups of piezoelectrical components such that the signal resolution of the touch position is improved. The foregoing description is taken as an example, and the disclosure does not limit the quantity of the receiving elements disposed in the touch sensing device 210.

The elements illustrated in FIG. 2A or FIG. 2B can be apply in a display panel so as to form a display panel having touch-sensing function. For example, referring to FIG. 3A, the display medium layer 203a is disposed in the first substrate 201 of FIG. 2A or FIG. 2B to form the touch display panel 200a, and the display medium layer 203a is located in the display area Al. The display medium layer 203a is driven by the active device array AA, and the display medium layer 203a and the touch sensing device 210 are located at the same side of the first substrate 201. Based on the design, the touch display panel 200a does not require other elements such as a cover lens to having both the display function and the touch sensing function.

According to FIGS. 2A and 2B, the width W of the non-display area A2 is small and thus the product using the touch display panel 200a can have larger display screen. The display medium layer 203a of the touch display panel 200a is, for example, an electrophoresis display film or an organic light emitting layer. That is to say, the touch display panel 200a is an electrophoresis display panel having touch sensing function or an organic light emitting display panel having touch sensing function. In fact, with different display medium layers 203a, the touch display panel 200a can be other types of display panels.

FIG. 3B illustrates a touch panel of another embodiment of the disclosure. As shown in FIG. 3B, in addition to the elements illustrated in FIG. 2A or FIG. 2B, the touch display panel 200b further includes a second substrate 205, and the display medium layer 203b is disposed between the first substrate 201 and the second substrate 205. The display medium layer 203b can be a liquid crystal layer, and the second substrate 205 can have a color filter layer CF. Alternatively speaking, the touch display panel 200b is a liquid crystal display panel having touch sensing function.

The above-mentioned description is not used to limit the disclosure. The color filter layer CF can be incorporated in the active device array AA of the first substrate 201 to form the design of a color filter on array (COA), or the active device array AA can be incorporated in the color filter layer CF to form the design of an array on color filter (AOC) in other embodiments. In addition, the touch display panel 200b further includes a first polarizer 242 and a second polarizer 244, and the first substrate 201 and the second substrate 205 are located between the first polarizer 242 and the second polarizer 244.

Furthermore, the display panel 200b may be a transflective touch display panel, a reflective touch display panel, a color filter on array touch display panel, an array on color filter touch display panel, a vertically-aligned (VA) touch display panel, an IPS touch display panel, an MVA touch display panel, a TN touch display panel, an STN touch display panel, a PVA touch display panel, an S-PVA touch display panel, an ASV touch display panel, an FFS touch display panel, a CPA touch display panel, an ASM touch display panel, an OCB touch display panel, an S-IPS touch display panel, an AS-IPS touch display panel, an UFFS touch display panel, a Blue phase touch display panel, a PSA touch display panel, a dual-view touch display panel, a triple-view touch display panel, a three-dimensional touch display panel, or other touch display panels.

The display medium layer 203b can further be material layers other than the liquid crystal layer. For example, the material of the display medium layer 203b can be plasma sandwiched between the first substrate 201 and the second substrate 205. If the plasma is used as the display medium, the first polarizer 242 and the second polarizer 244 can be omitted in the touch display panel 200b. In other embodiments, the material of the display medium layer 203b includes an electrophoresis display material, an organic light emitting material, an inorganic light emitting material, or the like.

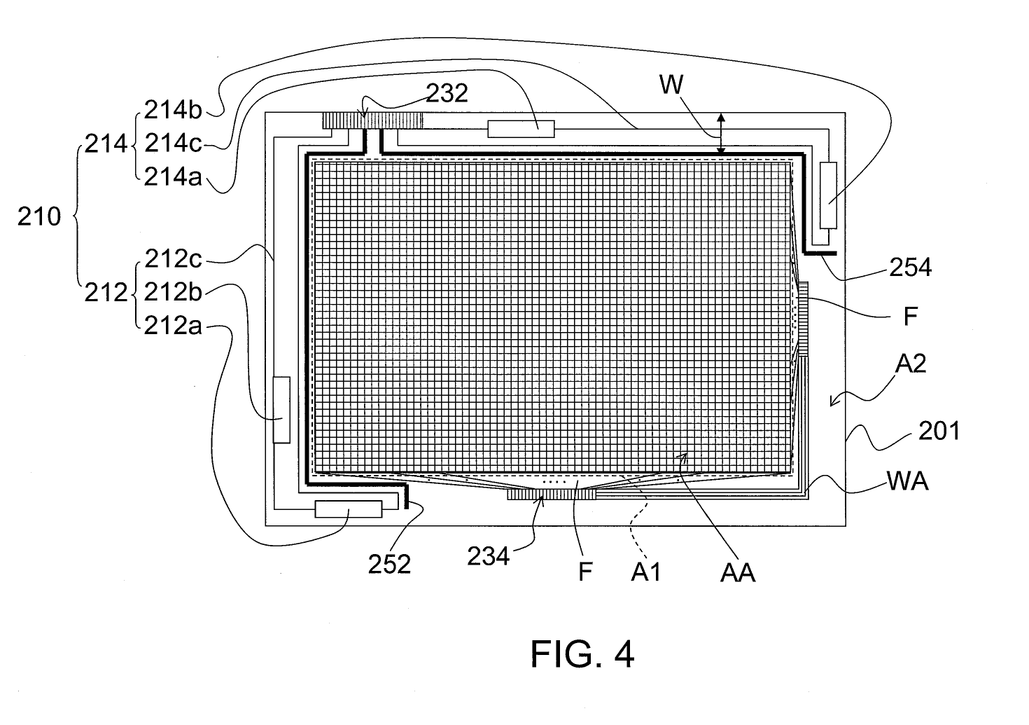

FIG. 4 is a schematic top view of a first substrate and the elements disposed thereon in a touch display panel according to further another embodiment of the disclosure. Referring to FIG. 4, a shielding line 252 and a shielding line 254 are further disposed on the first substrate 201, located between the active device array AA and the touch sensing device 210, and located in the non-display area A2. The shielding lines 252 and 254 are applied to a ground voltage or a common voltage.

The scan voltage transmitted by the scan lines and the display voltage transmitted by the data lines in the active device array AA are commonly larger than the electrical signal generated by the touch sensing device 210. Therefore, the shielding lines 252 and 254 can protect the electrical signals generated by the touch sensing device 210 from interfering by the signals in the display area A1 such as the noise generated by the signals transmitted in the scan lines and the data lines. It is worth to note that the line width of the shielding lines 252 and 254 illustrated in FIG. 4 are overstated for clearly describing, and in a real circumstance, the length, the position, and the line width of the shielding lines 252 and 254 can be modified according to different design principles.

In the above embodiments, the touch sensing device 210 and the active device array AA are incorporated disposed on the first substrate 201. Therefore, the transmitting lines 212c and 214c can be formed on the first substrate 201 simultaneously with the formation of the active device array AA by the photo-lithography process. Therefore, the screen printing process is omitted to simplify the manufacturing process and reduce the manufacturing cost of the touch display panel 200a and 200b. It is certainly not restricted that the touch sensing device 210 and the active device array AA are incorporated disposed on the first substrate 201. In addition, the application of the elements illustrated in FIG. 4 to the touch display panels 200a and 200b is conducive to improve the sensitivity of the touch sensing device 210.

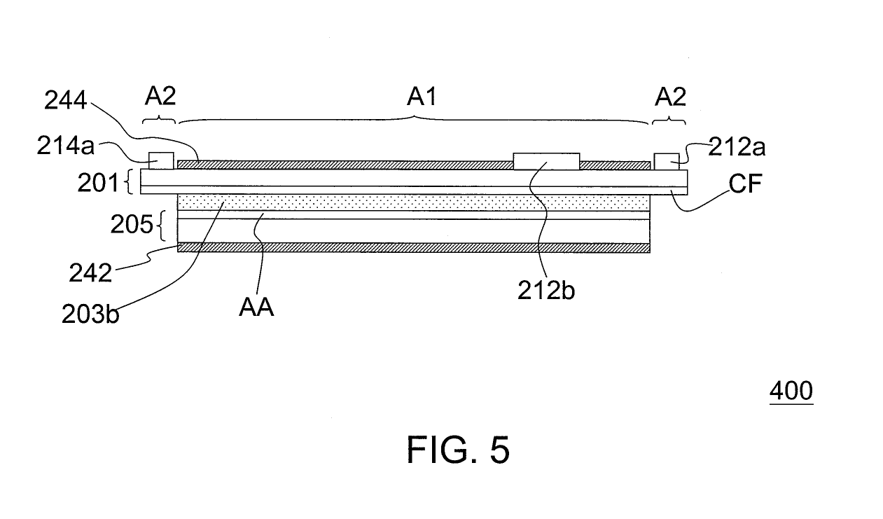

FIG. 5 is a schematic side view showing a touch display panel according to another embodiment of the disclosure. Referring to FIG. 5, the touch display panel 400 possesses all components shown in the touch display panel 200b, wherein identical elements are referred to by the same reference numbers, and detailed descriptions thereof are omitted hereinafter.

Nevertheless, in the touch display panel 400, the second substrate 205 has the active device array AA for driving the display medium layer 203b, and the touch sensing device (only the piezoelectrical components 212a, 212b, and 214a are shown in the schematic side view) is located at a side of the first substrate 201 away from the display medium layer 203b. Specifically, the material of the display medium layer 203b can be liquid crystals, plasma, or the display medium illustrated in FIG. 3B, which is driven by the active device array AA, and the first substrate 201 may have the color filter layer CF.

In short, the touch sensing device (only the piezoelectrical components 212a, 212b, and 214a are shown in the schematic side view) of the touch display panel 400 is, for example, incorporated with the color filter layer CF on the first substrate 201. Similarly, the touch display panel 400 also has the objectives and the technical features of the touch display panel 200a and 200b described above.

### Display Apparatus

The touch display panels according to the foregoing embodiments can be applied to a display apparatus, which is summarily discloses in the following.

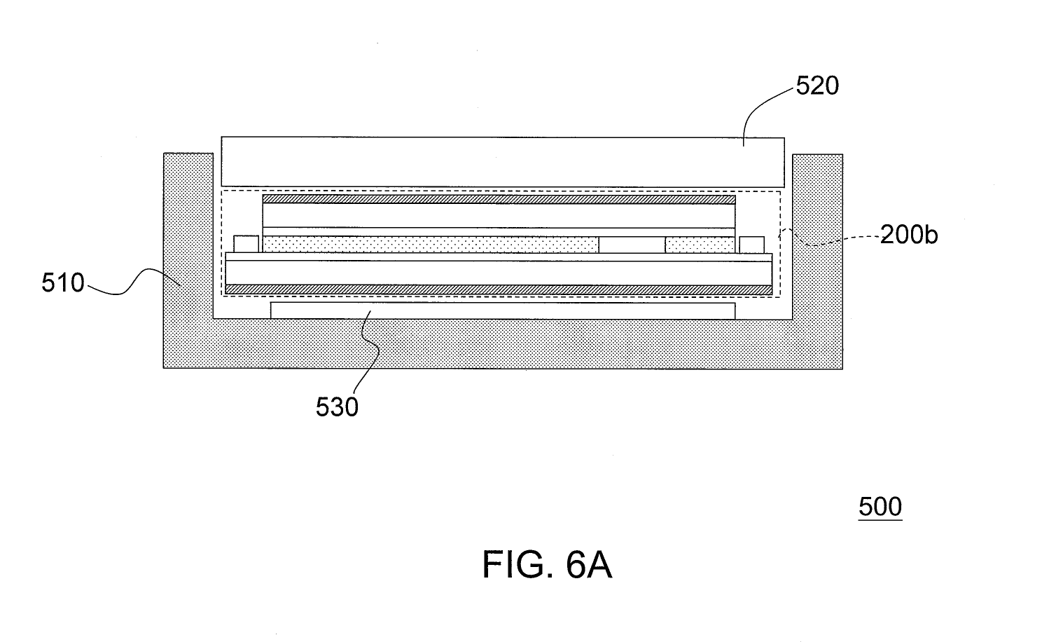

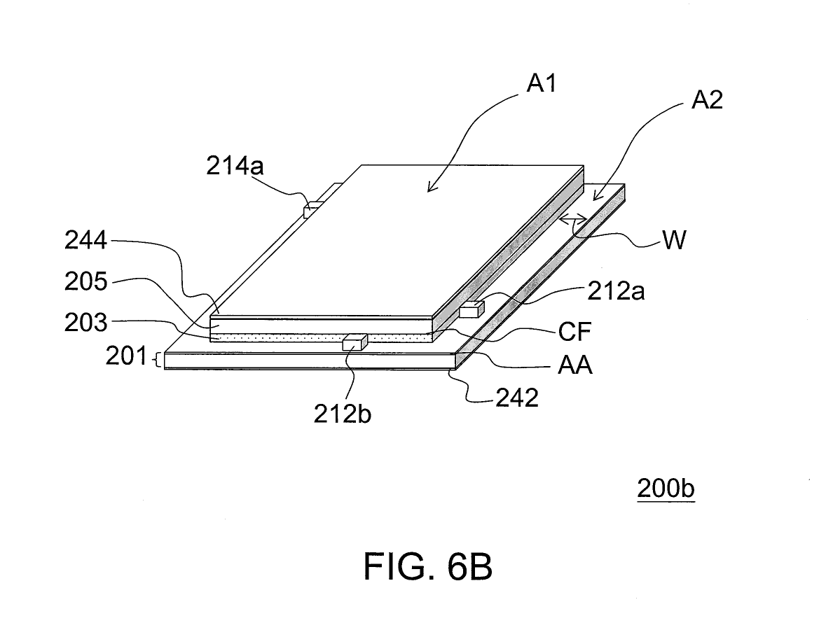

FIG. 6A is a schematic view of a display apparatus according to an embodiment of the disclosure. FIG. 6B is a schematic view of a touch display panel illustrated in FIG. 6A, wherein only a portion of the elements are shown. Referring to FIG. 6A and FIG. 6B, a display apparatus 500 includes a frame 510 which is also called an accommodating frame, a lower frame, or a bottom frame, and the above-mentioned touch display panel 200b. The touch display panel 200b is located inside the frame 510. The elements of the touch display panel 200b are referred to the foregoing embodiments.

The display apparatus 500 further includes a protective sheet 520 and a display light source 530. The protective sheet 520 is disposed on the frame 510 to cover the touch display panel 200b. The protective sheet 520 is, for example, a cover lens or other materials. The display light source 530 is disposed between the frame 510 and the touch display panel 200b. Nevertheless, the elements mentioned above are taken as examples. In fact, the protective sheet 520 is not necessary, and the display apparatus 500 of the disclosure may not have the protective sheet 520 in some embodiments. Furthermore, the display light source 530 is neither necessary. In some embodiments, the display apparatus 500 may not have the display light source 530 when the display medium layer is composed of self-illuminating materials such as plasma, organic light emitting materials, inorganic light emitting materials, or other self-illuminating materials.

The display apparatus 500 has the above touch display panel 200b and thus has the above-mentioned objectives and technical effects. Particularly, compared with the application of the conventional touch panel 100 to a display apparatus, the display apparatus 500 applying the touch display panel 200b has better space utilization and portability.

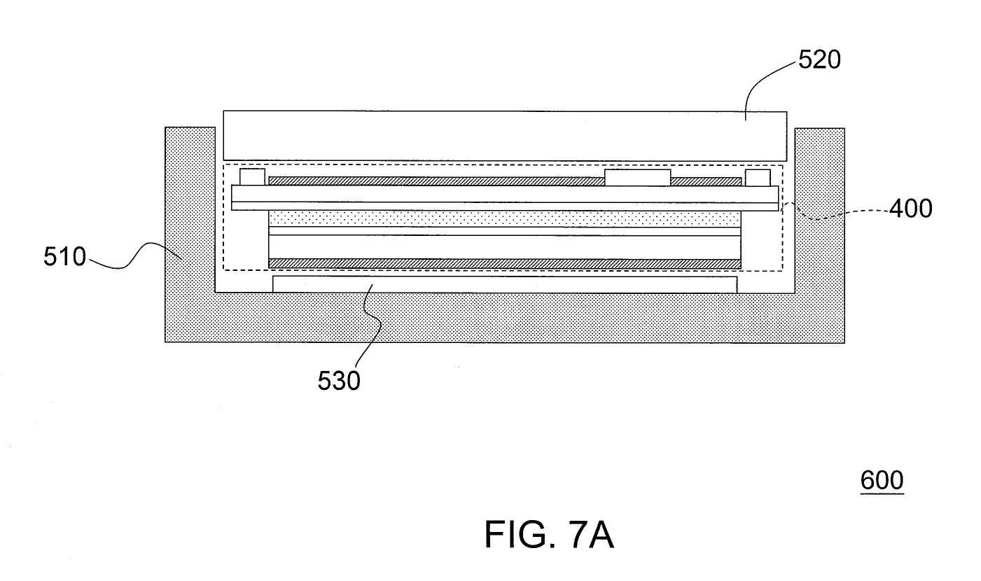

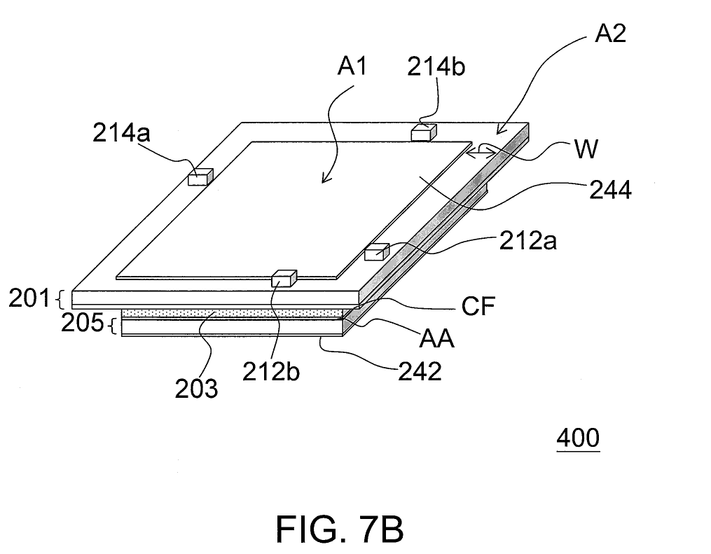

FIG. 7A is a schematic view of a display apparatus according to another embodiment of the disclosure. FIG. 7B is a schematic view of a touch display panel illustrated in FIG. 7A, wherein only a portion of the elements are shown. Referring to FIG. 7A and FIG. 7B, a display apparatus 600 is similar to the display apparatus 500, and identical elements are represented by the same reference numbers in the two figures. Therefore, detailed descriptions thereof are not repeated hereinafter. The main difference between the display apparatus 600 and the display apparatus 500 is that the touch display panel 400 is disposed in the display apparatus 600 to replace the display touch panel 200b shown in FIG. 6A. The elements of the touch display panel 400 are referred to the related description corresponding to FIG. 5, and the display apparatus 600 has the technical effects of the display apparatus 500.

In other embodiments, the touch display panels 200b and 400 disposed in the display apparatuses 500 and 600 can be replaced by the touch display panel 200a mentioned above or other touch display panels. The display apparatus 500 or 600 may not have the display light source 530 when the touch display panel 200a is applied thereto.

In summary, the touch sensing device may be directly disposed on the first substrate of the touch display panel according to the disclosure, and the transmitting lines can be made by the photo-lithography process and the etching process of the method for manufacturing the display panel. Therefore, the touch display panel according to the disclosure has high manufacturing precision and low transmitting line resistance, and the screen printing process is omitted to save the corresponding cost. In addition, the touch display panel of the disclosure using passive touch sensing device does not require an acoustic source which is the so-called signal emitting source or the signal emitting element. Accordingly, the design of the touch display panel of the disclosure is much simple. The touch display panel of the disclosure using passive touch sensing device does not require additional piezoelectrical components used as an acoustic source, and thus no additional power is needed for driving the acoustic source. In some embodiments, the touch display panel further has the shielding lines disposed between the transmitting lines and the display area so as to prevent the electrical signal generated by the touch sensing device from interfering by the noise. In addition, the line width of the transmitting lines in the display apparatus having the above touch display panel is reduced to conduce to narrow the width of the periphery area. In other words, the display apparatus of the disclosure has better space utilization and larger screen size.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A touch display panel, comprising:
a first substrate having a display area and a non-display area located outside the display area;
a touch sensing device disposed on the first substrate and located within the non-display area, wherein the touch sensing device is consisted of two or more groups of receiving elements; and
a display medium layer disposed in the display area.

2. The touch display panel as claimed in claim 1, wherein each group of the receiving elements is consisted of one or more piezoelectrical components and a transmitting line, and the transmitting line serially connects the one or more piezoelectrical components.

3. The touch display panel as claimed in claim 2, wherein a line straightly connecting any two piezoelectrical components does not pass through a center of the display area.

4. The touch display panel as claimed in claim 1, wherein the first substrate has an active device array, the display medium layer is driven by the active device array, and the display medium layer and the active device array are located at a same side of the first substrate.

5. The touch display panel as claimed in claim 4, further comprising at least a shielding line disposed between the active device array and the touch sensing device, located in the non-display area, and the shielding line being applied to a ground voltage or a common voltage.

6. The touch display panel as claimed in claim 4, wherein the first substrate further has a first pad portion and a second pad portion respectively located within the non-display area, the touch sensing device is connected to the first pad portion, and the active device array is connected to the second pad portion.

7. The touch display panel as claimed in claim 6, wherein the first pad portion and the second pad portion are respectively located at different sides of the display area.

8. The touch display panel as claimed in claim 1, further comprising a second substrate, and the display medium layer being disposed between the first substrate and the second substrate.

9. The touch display panel as claimed in claim 8, wherein the display medium layer is a plasma layer.

10. The touch display panel as claimed in claim 8, wherein the display medium layer is a liquid crystal layer.

11. The touch display panel as claimed in claim 10, further comprising a first polarizer and a second polarizer, and the first substrate and the second substrate are located between the first polarizer and the second polarizer.

12. The touch display panel as claimed in claim 8, wherein the second substrate has an active device array, the display medium layer is driven by the active device array, and the touch sensing device is located at a side of the first substrate away from the display medium layer.

13. The touch display panel as claimed in claim 8, wherein the first substrate or the second substrate has a color filter layer.

14. The touch display panel as claimed in claim 1, wherein the display medium layer is an electro-phoretic display film or an organic light emitting device layer.

15. The touch display panel as claimed in claim 1, wherein a width of the non-display area is 1 mm to 10 mm.

16. A display apparatus, comprising:
a frame; and
the touch display panel as claimed in claim 1 located in the frame.

17. The display apparatus as claimed in claim 16; further comprising a protective sheet disposed on the frame and covering the touch display panel.

18. The display apparatus as claimed in claim 16, further comprising a display light source disposed between the frame and the touch display panel.
